(19) United States
(12) Patent Application Publication
(10) Pub. No.: US 2009/0162543 A1
(43) Pub. Date: Jun. 25, 2009

(54) CONCENTRATED POWDERED COLORS COMPOSITION FOR A POWDER COATING AND METHOD OF MANUFACTURE

(76) Inventor: GIORA TOPAZ, Even Yehuda (IL)

Correspondence Address: SCHWEITZER CORNMAN GROSS & BONDELL LLP, 292 MADISON AVENUE - 19th FLOOR, NEW YORK, NY, 10017, US

(21) Appl. No.: 11/960,272

(22) Filed: Dec. 19, 2007

(51) Int. Cl. B05D 1/12; C08G 67/00

(52) U.S. Cl. 427/180; 524/612

(57) ABSTRACT

A concentrated powdered colors composition for use in powder coatings is made by mixing a binder with a coloring pigment in a dry blend mixer. The mixture is then strained to form a concentrated powdered colors composition. The concentrated powdered colors composition blends with a powder coating base in a uniform and effective manner when mixed in a dry blend mixer to produce a colored powder coating. The properties of the composition allow a colored powder coating to be compounded solely by using a dry blend mixer to mix the concentrated powdered colors with an otherwise end-product powder coating base.

### FIELD OF THE INVENTION

This invention relates generally to powder coatings and concentrated powdered colors therefor.

### BACKGROUND OF THE INVENTION

Powder coating is a technique of applying dry paint to various substrates. Powder coating has become very popular because it produces a hard finish that is tougher than conventional paint. Furthermore, powder coating is better for the environment than traditional painting methods because the cure or drying do not emit volatile organic compounds and produces less hazardous waste. Powder coating is frequently used for the coating of metal products such as automobile parts.

Powder coating is normally produced by mixing various uncolored components with other additives to produce a first mixture. The first mixture is then mixed with pigments and heated in an extruder to form a colored melt. The colored melt is processed by the extruder into various forms such as chips or pellets. The extruded product is then fed into a grinder and is ground into a powder ready to be applied. Occasionally, dependent on the needs of the end product, the powder is then sieved for better particle size distribution. The powder is then refined in a separator into a powder of suitable fineness to form a colored powder coating.

Powder coating is applied to a substrate typically by using a spray gun such as an electrostatic gun or corona gun. The spray gun imparts an electrostatic charge to the powder coating particles. The substrate is electrically grounded, which causes the charged powder coating to adhere to the substrate. A charging agent can be added to the coating mixture to give the powder coating an electrostatic charge. As an alternative to the use of a spray gun, the substrate can be dipped into a bed containing the powder coating to coat the substrate with the powder coating. Other methods common in the art involve using electrostatic discs or a magnetic brush to apply powder coating on the substrate. In all of these methods of applying powder coating to a substrate, the powder coating is then cured by heating the coated substrate.

While powder coatings are normally less expensive to produce as compared with conventional paints, the machinery required is still quite costly. Prior methods of preparing colored powder coatings from uncolored powder coating base known in the art require both an extruder and a grinder to add pigment to the uncolored powder coating base. The total cost for these machines are usually in excess of $500,000.

The machinery is in part necessary to add color pigment to a powder coating base since common pigments used for powder coating are very sticky and lumpy. Such pigments do not blend uniformly when simply mixed with a powder coating base and application of conventional pigments to a powder coating base creates a lumpy powder coating with uneven coloring. Lumpy powder coating is undesirable because, when it is applied to a substrate and cured, the lumps in the pigment melt and create a rough surface. While some metallic flake pigments can be simply mixed with a powder coating base, the range of colors and finished products are substantially restricted and limited.

A disadvantage of prior powder coatings is that the powder coatings are colored during the manufacturing stage and the color cannot be efficiently and effectively modified by the user. Therefore, a user may order too much powder coating of a certain color leading to waste. The user may also fail to order sufficient quantities of a certain colored powder coating resulting in delay of a painting step. Additionally, since the user cannot modify the color of the powder coating in an efficient and effective manner, a user desiring a specific color must rely on the manufacturer's ability to provide that colored powder coating. Therefore, it can be difficult or costly for a user to obtain small quantities of an uncommon or specialized color of powder coating.

Accordingly, it is an object of the present invention to provide a concentrated powdered colors composition for powder coating that allows the concentrated powdered colors composition to be combined uniformly to a powder coating base by use of a dry blending mixer.

An additional object of the present invention is to provide a method for manufacturing a concentrated powdered colors composition for powder coating that enables the concentrated powdered colors composition to be applied uniformly to a powder coating base by use of a dry blending mixer.

It is another object of the present invention to provide a concentrated powdered colors composition for powdered coatings that can be effectively blended with other colors of the concentrated powdered colors composition by the user in a dry blend mixer to form any desired color of concentrated powdered colors composition and can be applied uniformly to a powder coating base by the user.

Yet another object of the present invention is to provide a method for manufacturing colored or pigmented powder coatings that only require a dry blending mixer to add the colorant to an uncolored powder coating base and do not require an extruder or grinder for such a step.

Another object of the present invention is to provide an improved method for applying powder coating on a substrate.

Still a further object of the invention is to provide a method for manufacturing pigmented powder coatings that is efficient and cost effective.

### SUMMARY OF THE INVENTION

The foregoing objects are met by the present invention directed to a concentrated powdered colors composition for use in powder coatings and methods associated therewith. A concentrated powdered colors composition for powder coatings of the invention is made by mixing an uncolored binder with at least one coloring pigment in a dry blend mixer. The binder may be comprised of polyester, epoxy polyester, acrylic, epoxy phenolic and/or polyurethane. The mixing of the pigment with the binder in the dry blend mixer aerates the pigments and decreases the stickiness of the pigments. The aeration in the dry blend mixer also lowers the specific gravity of the pigment blend. The mixture is then strained to separate fine particles from any remaining lumpy material. The strained mixture is a concentrated powdered colors composition that may be added to an otherwise end-product powder coating base in a simple mixer to form colored powder coating, without need for further processing steps.

This method produces a novel concentrated powdered colors composition for use in powder coatings comprising a powdered mixture of pigment and an uncolored binder of polyester, epoxy polyester, epoxy phenolic, acrylic, and/or polyurethane. The preferred ratio of binder to pigment is in the range of 1:1 to 2:1 by weight.

The novel concentrated powdered colors composition blends with a powder coating base in a uniform and effective manner when mixed in a dry blend mixer to produce a colored powder coating. The concentrated powdered colors composition allows a colored powder coating to be prepared by a producer in small batches solely by using a dry blend mixer to mix the concentrated powdered colors composition with a conventional uncolored powder coating base. The need for further extruding or grinding of the powder coating blend is eliminated.

This dramatically decreases the costs of equipment and manufacture of colored powder coatings as well as the production time for manufacturing such powder coatings from uncolored powder coating base. Various colors of concentrated powdered colors composition can also be mixed with each other in a dry blend mixer to form any color of concentrated powdered colors composition. This allows a producer to add any color of concentrated powdered colors composition to a clear powder coating base by use of a dry blend mixer enabling the user to make any color of powder coating they desire.

### DETAILED DESCRIPTION OF PREFERRED EMBODIMENTS

The present invention is directed to a concentrated powdered colors composition for use in powder coatings and methods associated therewith. The concentrated powdered colors composition comprises an uncolored binder of polyester, epoxy polyester, acrylic, epoxy phenolic and/or polyurethane. The binder can include white or titanium white pigment of up to 16% concentration by weight. The binder is chosen to be compatible with the underlying formulation of the powder coating base to which the concentrated powdered colors composition will be added. In one embodiment, the binder comprises a TGIC polyester. In another embodiment, the material for the binder comprises a TGIC-free polyester. Alternatively, the binder may comprise an epoxy polyester blend in the range of 70/30 to 50/50 polyester to epoxy by weight. Such formulations are known in the art.

The concentrated powdered colors composition also comprises one or more conventional pigments. The pigments used may be pigments as typically used in the art, having any color within the visible spectrum of colors. The ratio of binder to pigment is preferably in the range of 1:1 to 2:1 by weight. When the binder includes white pigment of up to 16% concentration, the concentration of pigment is adjusted accordingly to produce the desired concentrated powdered colors composition. The concentrated powdered colors composition is preferably formed of granules having a diameter less than 100 microns.

The concentrated powdered colors composition is made by mixing the binder with at least one coloring pigment in a dry blend mixer of a type known in the art to form a first mixture. Alternatively, other machinery known in the art to blend dry materials may be used. The mixing of the pigments with the binder in the dry blend mixer aerates the pigments and decreases the stickiness of the mixture. The aeration of the pigments in the dry blend mixer also lowers the specific gravity of the pigments. It is preferred that the mixture is mixed for approximately twenty minutes. However, the time for mixing the mixture may vary significantly depending on the pigments used and the desired specific gravity of the mixture. The mixture is then strained to separate fine particles from any remaining lumpy material. In a preferred embodiment, the first mixture is strained by using a rotating sieve with apertures of 100 microns. Alternatively, other straining methods well known in the art may be employed. After being strained, the mixture forms a concentrated powdered colors composition in a powdered form.

The concentrated powdered colors composition has the ability to blend with an uncolored powder coating base in a uniform and effective manner when mixed in a dry blend mixer to produce a colored powder coating that could be directly applied to a substrate. Use of the concentrated powdered colors composition allows a powder coating of a desired color to be formulated solely by using a dry blend mixer to mix the concentrated powdered colors composition with a stock unpigmented powder coating base. The powder coating base may comprise a wide variety of bases known in the art and may be the same material as the binder. It is generally desired that the powder coating base is unpigmented. In embodiments where the powder coating base is generally the same material as the binder and the binder has up to 16% titanium white pigment, the powder coating base will differ from the binder by the absence of the titanium white pigment.

An improved method to make a colored powder coating involves using the concentrated powdered colors composition described above and mixing it with an unpigmented powder coating base. This improved method eliminates the need for extruding or grinding a powder coating formulation after pigment is added, as required by conventional processes, in order to produce a suitable colored powder coating with uniform distribution of the pigment. Thus, a stock of uncolored powder coating base may be maintained, with concentrated powdered colors composition being added thereto in a dry blend mixer as a final manufacturing step and in any volume required. Custom colored powder coatings can be efficiently produced in response to need and demand. The method also allows producers with only a dry blend mixer or similar device to make their own colored powder coating by mixing the concentrated powdered colors composition to a powder coating base in the dry blend mixer. The time for mixing the concentrated powdered colors composition and the powder coating base varies and may be in the range of 5-20 minutes. In order to customize the color of the powder coating, different colors of concentrated powdered colors composition can be mixed with each other to form a specific colored concentrated powdered colors composition. The concentrated powdered colors composition is then mixed with the binder in a dry blend mixer to form the precise color of concentrated powdered colors composition desired, which is then again combined with an uncolored powder coating base in the mixer to make colored powder coating.

As an example, RAL 1013 (pearl white) colored powder coating may be made in accordance with the present invention by mixing 74.76 kg of powder coating base with 40 grams of carbon black concentrated powdered colors composition, 20 grams of iron oxy red concentrated powdered colors composition, 400 grams of iron oxide yellow concentrated powdered colors composition, and 24.8 kg of titanium white concentrated powdered colors composition in a dry blend mixer for twenty minutes. The RAL 1013 colored powder coating formed by this process may then be applied to a substrate without further processing.

A further aspect of the present invention comprises an improved method for applying a powder coating to a substrate comprising the steps of preparing a colored powder coating as described above and then applying the colored powder coating by means well known in the art, such as by using a spray gun.

What is claimed is:

1. A method for making a concentrated powdered colors composition for use in powder coatings, comprising the steps of:
mixing a binder with at least one coloring pigment to form a first mixture; and
straining said first mixture to form a concentrated powdered colors composition for use in powder coatings.

2. The method for making a concentrated powdered colors composition as in claim 1, wherein said binder comprises at least one material from the group of polyester, epoxy polyester, epoxy phenolic, acrylic, and polyurethane.

3. The method for making a concentrated powdered colors composition as in claim 1, wherein said first mixture is mixed in a dry blending mixer.

4. The method for making a concentrated powdered colors composition as in claim 3, wherein said first mixture is mixed in a dry blending mixer for approximately twenty minutes.

5. The method for making a concentrated powdered colors composition as in claim 1, wherein said first mixture is strained by processing it through a sieve.

6. The method for making a concentrated powdered colors composition as in claim 5, wherein said sieve rotates and has apertures with a width of approximately 100 micron.

7. The method for making a concentrated powdered colors composition as in claim 1, wherein said binder is unpigmented.

8. The method for making a concentrated powdered colors composition as in claim 1, wherein said binder includes no more than a 16% concentration of white pigment by weight.

9. The method for making a concentrated powdered colors composition as in claim 1, wherein the ratio of binder to coloring pigment in said first mixture is in the range of 1:1 to 2:1 by weight.

10. A concentrated powdered colors composition for use in powder coatings comprising:
binder comprised of at least one material from the group of polyester, epoxy polyester, epoxy phenolic and polyurethane;
pigment;
said concentrated powdered colors composition is in a powder form; and
said ratio of binder to pigment is in the range of 1:1 to 2:1 by weight.

11. The concentrated powdered colors composition in claim 10, wherein said binder is comprised of TGIC polyester.

12. The concentrated powdered colors composition in claim 10, wherein said binder is comprised of TGIC-free polyester.

13. The concentrated powdered colors composition in claim 10, wherein said binder is comprised of an epoxy polyester in a range of 70/30 to 50/50 polyester to epoxy by weight.

14. The concentrated powdered colors composition in claim 10, wherein said binder is pigment-free.

15. A method for making a colored powder coating comprising making the concentrated powdered colors composition by the method of claim 1 and mixing the concentrated powdered colors composition with a powder coating base.

16. The method for making a colored powder coating in claim 15, wherein said concentrated powdered colors composition and said powder coating base are mixed in a dry blending mixer.

17. The method for making a colored powder coating in claim 16, wherein said concentrated powdered colors composition and said powder coating base are mixed in a dry blending mixer for approximately twenty minutes.

18. The method for making a colored powder coating in claim 15 wherein said concentrated powdered colors composition is made by mixing two different colored concentrated powdered colors compositions manufactured by the method of claim 1 in a dry blend mixer to achieve a concentrated powdered colors composition of a specific color to be mixed with the powder coating base.

19. The method for making a colored powder coating in claim 15, wherein said powder coating base is unpigmented.

20. The method for making a colored powder coating in claim 15, wherein said binder includes no more than a 16% concentration of white pigment by weight.

21. A method of applying a colored powder coating to a substrate, comprising the method for making a colored powder coating as in claim 15 and further comprising the steps of:
spraying said colored powder coating on a substrate by using a spray gun to form a coating; and
heating said substrate to cure the coating.
